(19) United States
(12) Patent Application Publication
(10) Pub. No.: US 2003/0061028 A1
(43) Pub. Date: Mar. 27, 2003

(54) Tool for automatically mapping multimedia annotations to ontologies

(75) Inventors: Jayanta K. Dey, Cambridge, MA (US); Rajendran M. Sivasankaran, Somerville, MA (US)

Correspondence Address: LACASSE & ASSOCIATES, LLC, 1725 DUKE STREET, SUITE 650, ALEXANDRIA, VA, 22314, US

(73) Assignee: KNUMI INC.

(21) Appl. No.: 09/956,889

(22) Filed: Sep. 21, 2001

(51) Int. Cl. G06F 17/27

(52) U.S. Cl. 704/9

(57) ABSTRACT

A tool for learning to relate annotations and transcript of a multimedia sequence to nodes in a formally or semi-formally represented ontology covering a broad range of possible multimedia documents. The device includes learning data preparation that involves certain special techniques for deriving data from the past mappings of annotations to nodes in an ontology, building inverted indices maintaining certain special statistics and a retriever that exploits these special statistics to rank the relevance of the nodes in an ontology for a given a set of new annotations.

### BACKGROUND OF THE INVENTION

1. Field of Invention

The present invention relates generally to the field of multimedia (video, audio, graphics, etc.) presentations authoring. More specifically, the present invention is related to intelligently integrating multimedia content and other contextually related content via an associative mapping system.

2. Discussion of Prior Art

Definitions have been included to help with a general understanding of associative mapping terminology and are not meant to limit their interpretation or use thereof. Other definitions or equivalents may be substituted without departing from the scope of the present invention.

Annotation: A comment attached to a particular section of a document. Many computer applications enable a user to enter annotations on text documents, spreadsheets, presentations, images, and other objects. It should be noted that the terms “annotation” and “keyword” equivalent and are therefore used interchangeable throughout the specification.

Ontology: The hierarchical structuring of knowledge about objects by sub-categorizing based on their relevant qualities.

The following references describe prior art in the field of associate mappers. The prior art mentioned below describe associative mapping in general, but none provide the benefits of the present invention's method and system for automatically mapping multimedia document annotations (or keywords) to ontologies.

U.S. Pat. No. 5,056,021 to Ausborn provides for a method and apparatus for abstracting concepts from natural language, wherein each word is analyzed for its semantic content by mapping into its category of meanings within each of four levels of abstraction. Each word is mapped into the various levels of abstraction, forming a file of category of meanings for each of the words. This is a manual process done by knowledge engineers prior to using this file for abstracting meanings from natural language words.

U.S. Pat. No. 6,061,675 to Wical provides for a method and apparatus for classifying terminology utilizing a knowledge catalog, wherein the static ontologies store all senses for each word and concept giving a broad coverage of concepts that define knowledge. A knowledge catalog processor accesses the knowledge catalog to classify input terminology based on the knowledge concepts in the knowledge catalog.

These prior art systems are not very suitable for automatically learning to relate loosely defined or unstructured contextual information (such as annotations or keywords or captions or transcripts) of a multimedia document sequence to formally or semi-formally represented ontologies related to sequences of multimedia documents. The following are some of the main problems associated with conventional associative mappers:

The process of building the catalog or indices is not automatic and needs elaborate human engineering to attach the words to concepts or nodes in the ontology (or taxonomy, interchangeably used from hereon).

In the domain of mapping multimedia document annotations, prior engineering of words by attaching them to concepts in the ontology is not feasible due to the drifting nature of the relevance of words to concepts in the ontology.

Conventional associative mappers do not deal with groups of words (as in annotations) that occur together (and not a full natural language sentence), and hence lead to issues like topic cross talk (described in detail later). Annotations in multimedia documents usually tend to be about more than one topic. This leads to problems in learning from data derived from past annotation mappings.

Conventional associative mappers rely on natural language processing systems that require more processing.

Associative mappers described in prior art systems fail to provide for a multimedia document authoring environment that helps rapidly create a document that integrates multimedia content with other content that is relevant to a segment of the multimedia document. Furthermore, prior art systems fail to describe an information retrieval mechanism that intelligently combines and renders multimedia content with other contextual content via a server on a network.

In these respects, the tool for mapping multimedia document annotations to ontologies according to the present invention substantially departs from the conventional concepts and designs of the prior art. Thus, it provides an apparatus primarily developed for the purpose of learning to map annotations or captioning of multimedia documents to nodes or concepts in formally or semi-formally represented ontologies covering a broad range of possible multimedia documents.

Whatever the precise merits, features and advantages of the above cited references, none of them achieve or fulfill the purposes of the present invention.

### SUMMARY OF THE INVENTION

A tool is introduced for automatically mapping multimedia annotations to ontologies wherein the same is utilized for learning to relate annotations or captioning of a multimedia document to nodes or concepts in formally or semi-formally represented ontologies covering a broad range of possible multimedia documents. Therefore, the associative mapper of the present invention provides for a multimedia document authoring environment that helps rapidly create a document that integrates multimedia content with other content that is relevant to the multimedia segment. Furthermore, the associative mapper of the present invention is used in conjunction with a server in a network to render an integrated presentation comprising multimedia document and other contextually related content.

The key components of the system of the present invention include:

1. Learning data preparation component that involves techniques for deriving data from past mappings of annotations (or keywords) to nodes in a taxonomy or an ontology. Learning represents the ability of a device to improve its performance based on the past performance data;

2. Intelligent inverted indices component maintaining statistics, and

3. A retriever that exploits these statistics to rank the relevance of the nodes in a taxonomy for a given set of new annotations.

The above-mentioned learning data preparation component, intelligent inverted index component or IIndex (for maintaining certain special statistics), and a retriever (that exploits the statistics maintained by IIndex to rank the relevance of the nodes in a taxonomy for given a set of new annotations) form the main components of this invention. Thus, the present invention provides for a technology for automatic and dynamic mapping of multimedia documents to ontologies via the three components described above.

Thus, the more important features of the present invention have been outlined, rather broadly, in order that the detailed description thereof may be better understood and that the present contribution to the art may be better appreciated. There are additional features of the invention that will be described hereinafter.

Other advantages of the present invention will become obvious to the reader and it is intended that these advantages are within the scope of the present invention.

### BRIEF DESCRIPTION OF THE DRAWINGS

FIG. 1a illustrates an overview of the learning data component associated with the system of the present invention.

FIG. 1b illustrates an example of mapped nodes in a taxonomy.

FIG. 2 illustrates an overview of the method associated with the system in FIG. 1.

FIG. 3 illustrates the method associated with learning data preparation.

FIG. 4 illustrates a statistical calculation maintained by the IIndex of the system of the present invention.

FIG. 5 illustrates a graph of a second component associated with the weighting factor wt_cf.

FIG. 6 illustrates a statistical calculation maintained by the retriever component of the system of the present invention.

FIG. 7 illustrates the method associated with the interactive multimedia document authoring environment.

FIG. 8 illustrates ways of obtaining various multimedia document annotations.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. Furthermore, it is to be understood that the phraseology and terminology employed herein are for the purpose of the description and should not be regarded as limiting.

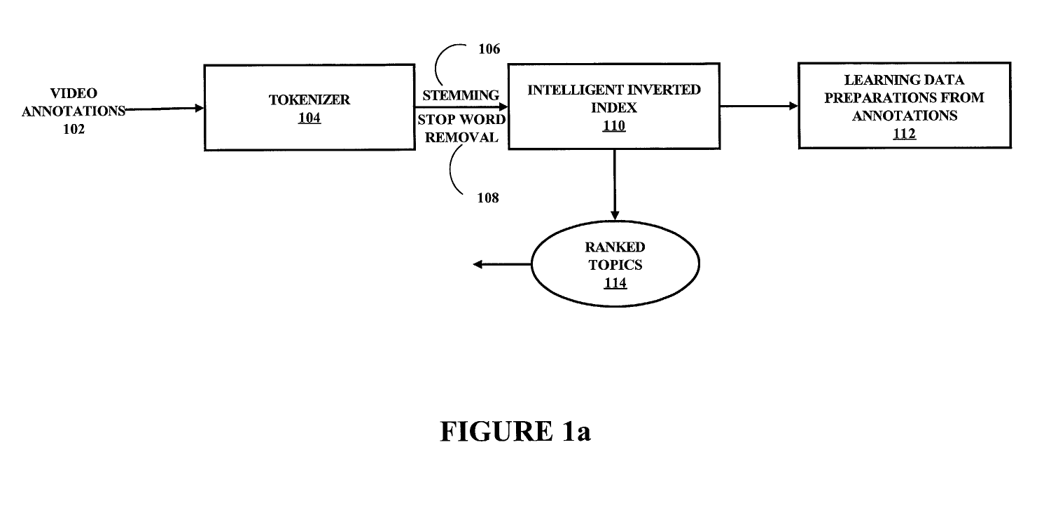

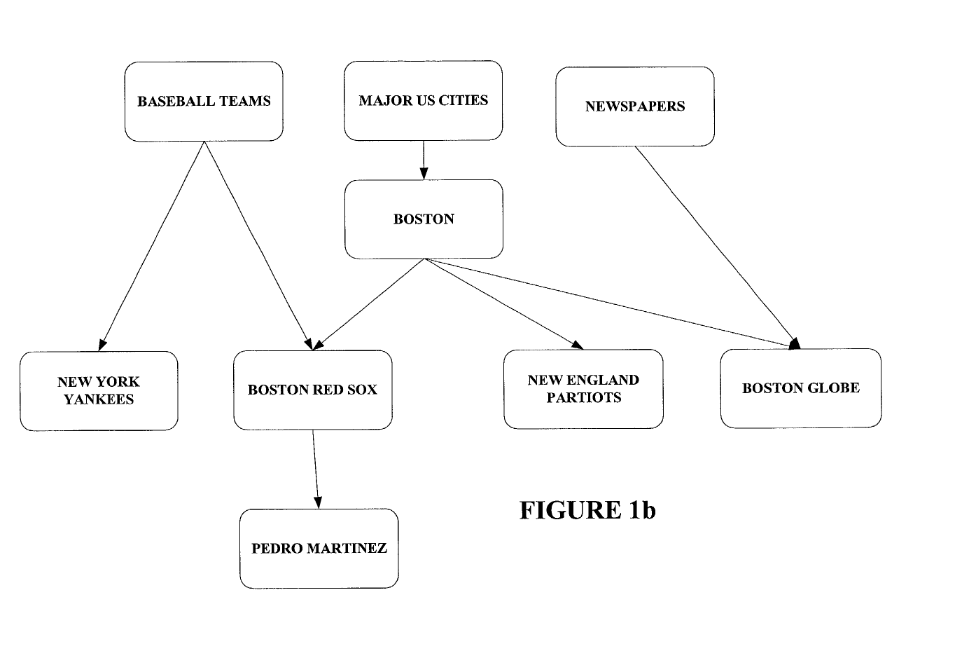

FIG. 1a illustrates an overview of components associated with the system of the present invention. A learning data preparation component looks at the annotations (e.g., multimedia annotations 102) and their past mappings into the nodes in the taxonomy and prepares the learning instances, one per node in the taxonomy. FIG. 1b illustrates an example of mapped nodes in a taxonomy. In this example, the “Boston” node is linked to three nodes: “Boston Red Sox”, New England Patriots”, and “Boston Globe”. But, the “Boston Red Sox” node is also linked to the “Baseball Teams” node (and so is the “New York Yankees” node), and similarly the “Boston Globe” node is also linked to the “Newspapers” node. Furthermore, the “Boston” node is also linked to the “Major US Cities” node. Lastly, the “Pedro Martinez” node is linked to the “Boston Red Sox” node.

Returning to the discussion in FIG. 1a, the prepared learning instances are tokenized (via tokenizer 104), stemmed 106, stop words are removed 108, and passed on to the IIndex 110. This component generates tf, idf and cf statistics for the learning instances (from learning data prepared from annotations 112) and creates an inverted index that is a data structure that maps words to nodes to which those words are associated.

Thus, the learning data preparation occurs prior to the search process. During the search process, the retriever looks at new annotations and uses the inverted index to retrieve and rank most relevant nodes for these annotations. The ranking process uses equations 1, 2, 3, and 4 (discussed below) to calculate the weights and rank the nodes (thereby forming ranked topics 114) in the order of their relevance.

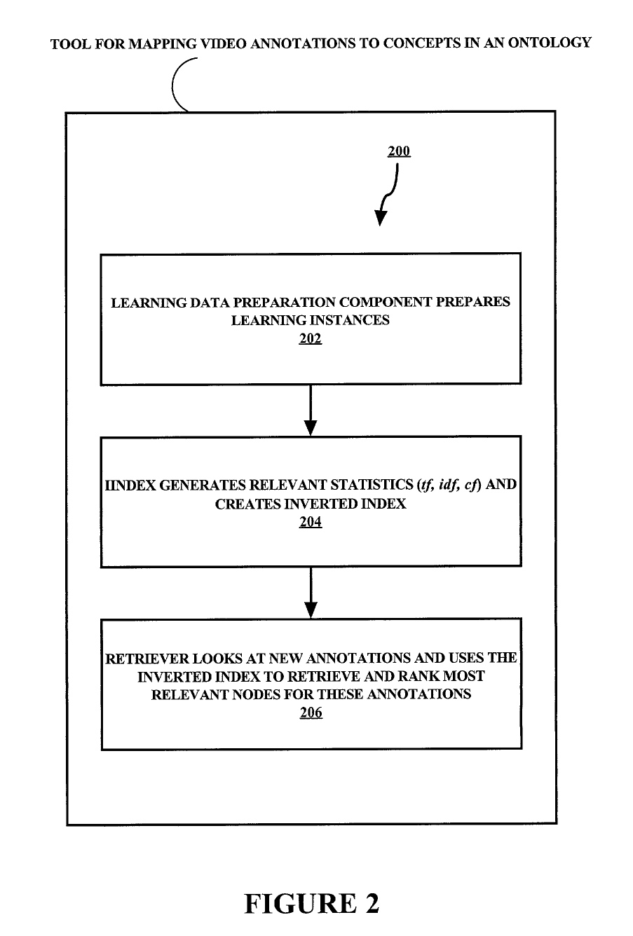

FIG. 2 illustrates an overview of the method 200 associated with the system in FIG. 1, wherein the learning data preparation component looks at the annotations and their past mappings, to the nodes in the taxonomy and prepares the learning instances 202, one per node in the taxonomy. IIndex treats these learning instances as a bag of words to be indexed and generates tf, idf and cf statistics for them and creates an inverted index 204. During the search process, the retriever looks at new annotations and uses the inverted index to retrieve and rank most relevant concepts from the ontology 206.

A detailed description of the above described learning system, intelligent inverted index, and retriever mechanisms are provided below:

Learning Data Preparation:

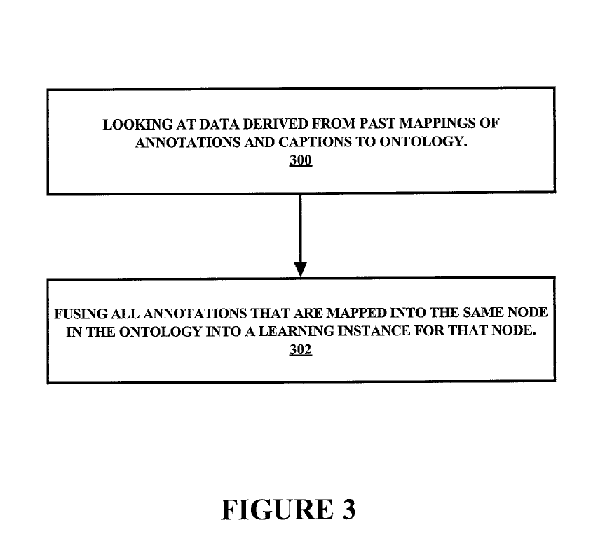

Learning represents the ability of a system or device to improve its performance based on past performance data. A learning system has to be endowed with the capability to look at the past performance data and derive abstract patterns of regularities that are generalized to novel situations. Learning data preparation, as illustrated in FIG. 3, involves looking at the data derived from past mappings of annotations and captions to the ontology 300 and fusing all annotations that are mapped into the same node in the ontology into a learning instance for that node 302. The fused annotations make words relevant to the node standout more than in individual annotations. Such a fusing also solves the problems of “short documents” that lead to poor results when using classical information retrieval techniques. Fusing annotations also lead to lesser sensitivity to errors in mappings. One of the most significant gains from fusing annotations mapped to a node for forming a learning instance vector is the mitigation of the topic cross talk problem. Supposing the annotations associated with topics “basketball” and “shoes” are detailed and long, where as those that are associated with “basketball” and “injury” are sparse and short. Then, a query associated with “basketball” and “injury” is likely to lead to the retrieval of the nodes related to “shoes” because of high term-frequencies for terms related to “basketball” and “shoes” in these annotations and low term-frequencies for terms related to “basketball” and “injury” annotations. This phenomenon is defined as “topic cross talk”. Each annotation is associated with more than one topic. Hence, words related to more than one particular topic occur in an annotation and get associated with that topic. Later, a discussion of the details of the mitigation of topic cross talk is provided. It relies on a statistical mechanism called “contribution frequency” that relies on the fused annotations.

Intelligent Inverted Index for Maintaining Certain Special Statistics:

IIndex starts with standard information retrieval (IR) technology (for building inverted indices for unstructured information) and incorporates a number of enhancements to make it effective for the task of relating annotations and captioning to nodes in a taxonomy. Standard IR systems rely on building an inverted index that is a data structure that maps words to documents in which those words occur. In addition, the inverted index also maintains certain statistics like term frequency (tf) and inverse document frequency (idf) for the words and their corresponding documents. Term frequency tfᵢⱼ is the number of times a particular word i occurs in a document j. Document frequency dfᵢ represents the number of documents in the entire document database in which the word i occurs at least once. As shown in FIG. 3, the system of the present invention relies on these statistics and augments them with a novel statistic called “contribution frequency”, denoted by cf, that is particularly suited to avoid topic cross talk in learning instances derived from fused annotations. For each word in a fused learning instance, its cf is just the number of annotations (that comprise the instance) in which the word appears. The statistic tc is the total number of annotations that comprise that learning instance.

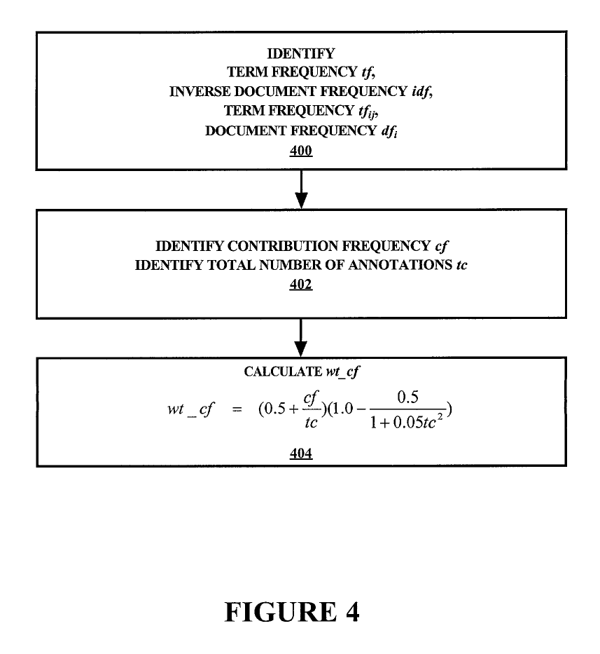

Furthermore, FIG. 4 illustrates a statistical calculation maintained by the IIndex of the system of the present invention. Standard statistical calculations like inverse document frequency (idf), term frequency (tf), and document frequency (df) are identified in step 400. Next, two of the above-described statistics: contribution frequency (cf) and total number of annotations (tc) are identified in step 402. In step 404, a weighting factor (wt_cf) with regard to the contribution frequency (cf) is calculated.

The weighting factor wt_cf, is calculated based on:

$$wt\_cf = {( 0.5 + \frac{c f}{t c} )}_{{\_}_{{\vert}_{Component 1}}} {( 1.0 - \frac{0.5}{1 + 0.05 t {c}^{2}} )}_{{\_}_{{\vert}_{Component 2}}}$$

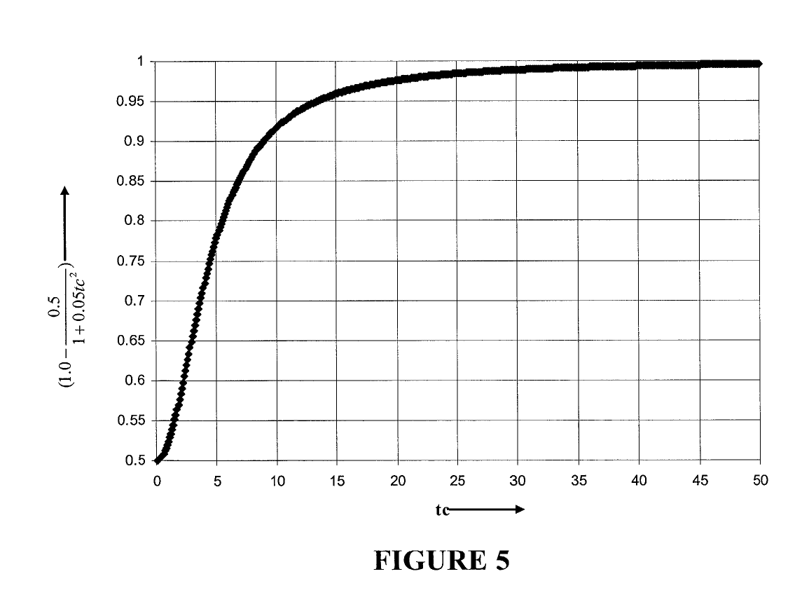

The wt_cf measure consists of two components. The first component takes care of the fact that the higher the cf with respect to tc, the higher the wt_cf Thus, the higher the contribution frequency of a word to a particular concept, then the higher its weight in determining the relevance of the concept. The addition of constant 0.5 makes wt_cf less sensitive to this ratio. The second component has a functional form as in FIG. 5. This component takes on the role of assigning fewer weights to the evidence derived from the cf/tf ratio when the number of abstracts comprising a learning instance is small. In other words, occurring in 2 abstracts out of 5 total abstracts in a topic document is not the same as occurring in 20 abstracts out of 50. The evidence in the latter case is stronger. However, once the total abstracts is more than about 30 (this parameter was experimentally determined to be optimal for the domain of multimedia annotation mapping), the second component levels off at 1.0.

Retriever Mechanism to Exploit the Special Statistics Maintained by IIndex:

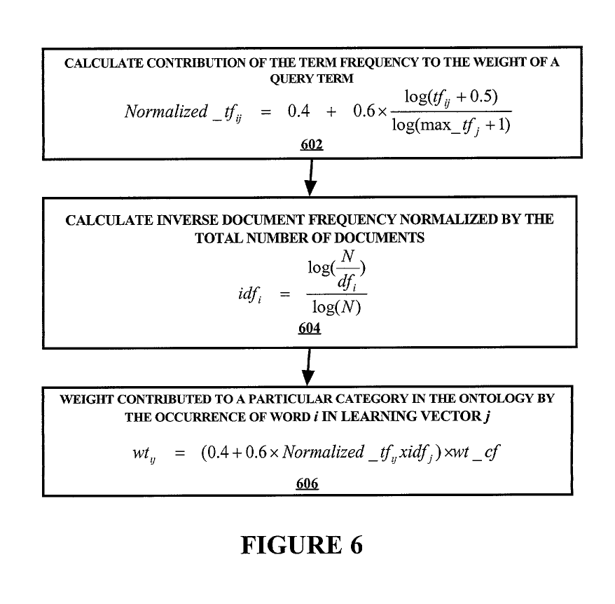

The retriever exploits the special statistic maintained by IIndex to rank the relevance of the nodes in a taxonomy for given set of new annotations. The retrieval mechanism uses the same measures as the intelligent indexing mechanisms that IIndex uses. It relies on tf, idf and cf and uses Equations 1, 2, 3, and 4 (given below) to rank the retrieved nodes in their order of relevance to a new annotation. FIG. 6 illustrates the statistical calculations performed by the retrieval mechanism. Contribution of the term frequency to the weight of a query term (Normalized_tfᵢⱼ) is calculated in step 602 (Equation 1). In step 604, an inverse document frequency (idf) is calculated, wherein the idf is normalized with respect to the number of documents (Equation 2). Lastly, a calculation is performed, as in step 606, to identify the weight contributed to a particular category in the ontology by the occurrence of word i in learning vector j (Equation 4).

$$E q u a t i o n 1 \text{:}$$

$${Normalized\_tf}_{if} = 0.4 + 0.6 \times \frac{log ( {tf}_{ij} + 0.5 )}{log ( {max\_tf}_{j} + 1 )}$$

$$E q u a t i o n 2 \text{:}$$

$${idf}_{i} = \frac{log ( \frac{N}{{df}_{i}} )}{log ( N )} ,$$

where “N” is the total number of documents.

$$E q u a t i o n 3 \text{:}$$

$$w t\_cf = ( 0.5 + \frac{cf}{tc} ) ( 1.0 - \frac{0.5}{1 + 0.05 t {c}^{2}} )$$

wtᵢⱼ=(0.4+0.6×Normalized_{—}tf ᵢⱼxidfⱼ)×wt_{—}cf Equation 4

As stated earlier, term frequency “tfᵢⱼ” is the number of times a particular word i occurs in a document j. “max_tfⱼ” is the maximum term frequency of all the terms in document j. Document frequency dfᵢ represents the number of documents in the entire document database in which the word i occurs at least once. The statistic, cf, is the number of annotations (that comprise the instance) in which the word appears. Furthermore, the statistic, tc, is the total number of annotations that comprise that learning instance. The statistic, wt_cf is the weighting factor due to the contribution frequency. “wtᵢⱼ” is the weight contributed by the occurrence of word i in document j.

Equation 1 defines the contribution of the term frequency to the weight of a query term. The fraction log (tfᵢⱼ+0.5)/log(max_{—tf}ⱼ+1) defines normalized term frequency adjusted for the possibility of tfᵢⱼ being zero. The addition of small positive quantities to tfᵢⱼ and max_tfⱼ avoids applying log to a zero (this is undefined). The multiplicative constants 0.4 and the additive constant 0.6 reduce the sensitivity of normalized_tfᵢⱼ to the fraction log(tfᵢⱼ+0.5)/log(max_tfⱼ+1). Equation 2 defines the inverse document frequency normalized by the total number of documents N. Equation 3 has been described previously with respect to FIG. 5. Equation 4 takes the combined effects of normalized term frequency, inverse document frequency, and contribution frequency to arrive at the weight contributed to a particular category in the ontology by the occurrence of word i in learning vector j.

### EXAMPLE IMPLEMENTATIONS

In one embodiment, the above-mentioned tool is part of a larger system that allows delivery of multimedia content integrated with other contextual content. This integrated experience is accessed via several devices, such as an interactive television, a computer, a telephone, a fax machine, or a handheld device, connected to the Internet, a cable system or a wireless network. Contextually related content is of several types: (i) text documents such as product bulletins, manuals, data sheets, press releases, news stories, biographies, analyst documents, (ii) message boards, chat rooms, (iii) product descriptions with instant purchase abilities (e-commerce), (iv) other multimedia documents consisting of audio, video, images and graphics in various formats, etc.

The system is unique in that it largely automates the end-to-end process of linking contextual content to multimedia presentations. Current systems allow a content producer to handcraft such an experience, leading to high resource requirements and lower productivity. We describe two major components of the system below:

A. Interactive Multimedia Authoring Environment:

The multimedia authoring environment enables a broadband producer to rapidly create a document that integrates multimedia content with other content that is relevant to the multimedia segment. Other relevant content resides on the Internet or within the intranet environment that the producer is in.

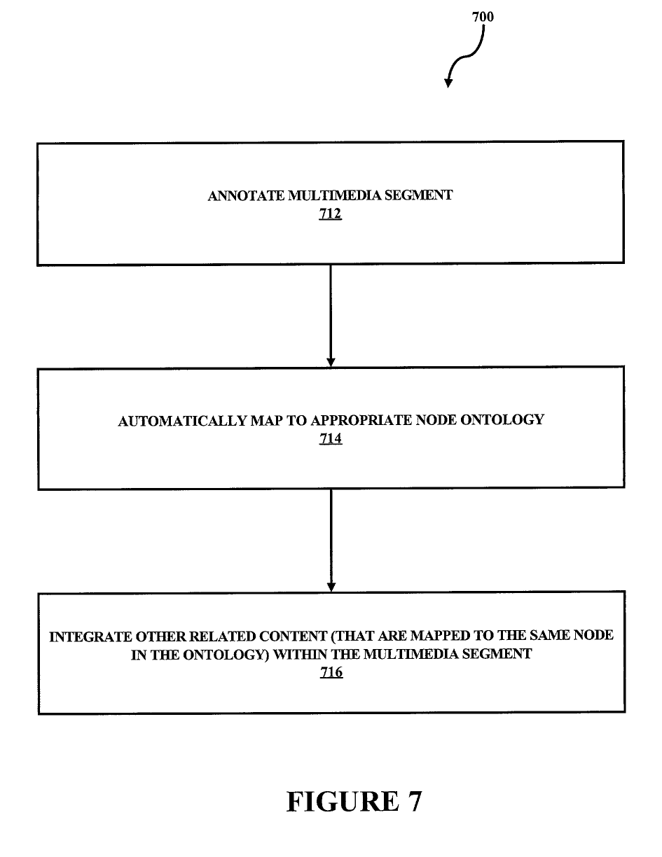

Currently, the producer would have to manually “attach” or “link” such content with the multimedia content. FIG. 7 illustrates the method (700) associated with the interactive multimedia authoring environment wherein using the automatic mapping tool, the producer annotates the multimedia segment only 712. Then the multimedia segment is automatically mapped to the appropriate node in the ontology 714. Other related content that are mapped to the same node in the ontology are then to be integrated along with the multimedia segment 716.

Producers have two options: They either (a) go through the related content, and pre-certify what is to be displayed to the viewer, or (b) allow dynamic content linking (described below).

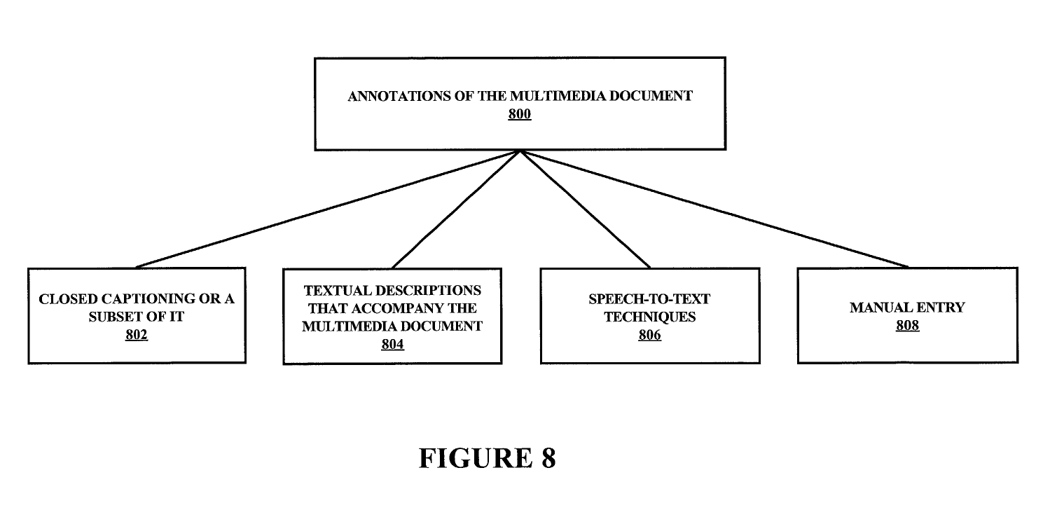

FIG. 8 illustrates some of the many ways to obtain annotations of the multimedia document 800: (a) using existing closed captioning or a subset of it 802, (b) using textual descriptions that accompany the multimedia document 804, (c) by employing speech-to-text techniques 806, and (d) by manually entering words that describe important aspects of a segment 808.

B. Interactive Multimedia Delivery Server:

The Interactive Multimedia Delivery Server is responsible for presenting an integrated presentation consisting of multimedia and other contextually related content.

The unique architecture of this Interactive Multimedia Document Delivery Server is that the contextual information is not sent to user before it is requested (by the user). Whenever contextual information is needed by the end-user, the time within the multimedia document is used to determine the context within the presentation. Using this information, the server retrieves contextual information using searching it's own ontology and databases using Information Retrieval techniques, as well as sending queries to other databases and web sites. This dynamic content linking allows for information to be up-to-date as well as eliminate expired information.

Furthermore, the present invention includes a computer program code based product, which is a storage medium having program code stored therein, which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM or any other appropriate static or dynamic memory, or data storage devices.

Implemented in computer program code based products are software modules for: receiving a request for searching and extracting one or more annotations related to said multimedia documents from an ontology; identifying nodes in the ontology that are relevant to the multimedia documents, wherein the nodes further comprises fused learning instances formed by fusing annotations based upon using statistics including term frequency, inverse document frequency and contribution frequency; and extracting information from said identified relevant nodes and dynamically linking said extracted information with said multimedia documents.

### Conclusion

A system and method has been shown in the above embodiments for the effective implementation of a tool for automatically mapping multimedia annotations to ontologies. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, or specific computing hardware.

The above enhancements for a method and a system for automatically mapping annotations of multimedia documents to ontologies and its described functional elements are implemented in various computing environments. For example, the present invention may be implemented on a conventional IBM PC or equivalent, multi-nodal system (e.g. LAN) or networking system (e.g. Internet, WWW, wireless web). All programming and data related thereto are stored in computer memory, static or dynamic, and may be retrieved by the user in any of: conventional computer storage, display (i.e. CRT) and/or hardcopy (i.e. printed) formats. The programming of the present invention may be implemented by one of skill in the art of statistical and network programming.

1. An interactive multimedia delivery system dynamically linking contextual information with multimedia documents, said system retrieving said contextual information by searching an ontology and one or more databases over a network, said ontology comprising one or more nodes, said system comprising:
a. a learning data preparation component accessing mappings of annotations in said ontology and fusing annotations mapped in each of said nodes to form learning instances;
b. an intelligent inverted index creating a data structure based on the following calculated statistics for said learning instances: term frequency (tf), inverse document frequency (idf), and contribution frequency (cf);
c. a retriever receiving a request for new annotations associated with multimedia documents, said retriever utilizing said inverted index to retrieve and rank most relevant nodes for said received new annotations, said ranking determined based upon a weight, wtᵢⱼ, contributed to a particular node in said ontology by the occurrence of a word i in a learning instance j;
d. an information retriever extracting information related to said requested annotations from said most relevant nodes and said one or more databases over said network, and
e. a contextual information linker linking multimedia content with said extracted information.

2. An interactive multimedia delivery system dynamically linking contextual information with multimedia documents, as per claim 1, wherein said weight wtᵢⱼ is given by:
wtᵢⱼ=(0.4+0.6×Normalized_{—}tf ᵢⱼxidfⱼ)×wt_{—}cf

3. An interactive multimedia delivery system dynamically linking contextual information with multimedia documents, as per claim 1, wherein said multimedia documents comprises audio, text, graphics, video documents.

4. An interactive multimedia delivery system dynamically linking contextual information with multimedia documents, as per claim 1, wherein said annotations are accessible via any of the following devices: an interactive television, a computer, a portable computer, a handheld device, or a telephone.

5. An interactive multimedia delivery system dynamically linking contextual information with multimedia documents, as per claim 1, wherein said network is any of the following: wide area network (WAN), local area network (LAN), wireless network, the telephony network, or the Internet.

6. An interactive multimedia delivery system dynamically linking contextual information with multimedia documents, as per claim 1, said learning data preparation further comprising:
a tokenizer, which tokenizes said learning instances;
a stemmer which stems said tokenized learning instances, and
a stop-word-remover, which removes stop words from said stemmed tokenized learning instances.

7. A method for searching an ontology of mapped multimedia annotations for appropriate annotations for one more multimedia documents, said ontology comprising one or more nodes, said method comprising the steps of:
a. receiving a request for searching and extracting one or more annotations related to said multimedia documents from said ontology;
b. identifying nodes in said ontology that are relevant to said multimedia documents, said nodes further comprising fused learning instances formed by fusing annotations in each of said nodes, said identification based upon using special statistics including term frequency, inverse document frequency and contribution frequency;
c. extracting information from said identified relevant nodes, and
d. dynamically linking said extracted information with said multimedia documents.

8. A method for searching an ontology of mapped multimedia annotations for appropriate annotations for one more multimedia documents, as per claim 7, wherein said multimedia documents comprises audio, text, graphics, video documents.

9. A method for searching an ontology of mapped multimedia annotations for appropriate annotations for one more multimedia documents, as per claim 7, wherein said annotations are accessible via any of the following devices: an interactive television, a computer, a portable computer, a handheld device.

10. A method for searching an ontology of mapped multimedia annotations for appropriate annotations for one more multimedia documents, as per claim 7, said method further comprising:
tokenizing said learning instances;
stemming said tokenized learning instances, and
removing stop words from said stemmed tokenized learning instances.

11. A method for retrieving contextual information by searching an ontology and one or more databases, said method comprising:
receiving a request for contextual information;
retrieving from an ontology, with automatically mapped annotations, said requested contextual information using information retrieval statistics;
retrieving said requested contextual information from one or more databases, and
rendering an integrated presentation comprising audio, video, or graphics and said retrieved contextual information.

12. A method for retrieving contextual information by searching an ontology and one or more databases, as per claim 11, wherein said information retrieval statistics include calculating the following parameters:
$$1 ) {Normalized\_tf}_{ij} = 0.4 + 0.6 \times \frac{log ( {tf}_{ij} + 0.5 )}{log ( {max\_tf}_{j} + 1 )} \\ 2 ) {idf}_{i} = \frac{log ( \frac{N}{{df}_{i}} )}{log ( N )} \\ 3 ) wt\_cf = ( 0.5 + \frac{cf}{tc} ) ( 1.0 - \frac{0.5}{1 + 0.05 t {c}^{2}} ) \\ 4 ) w {t}_{ij} = ( 0.4 + 0.6 \times {Normalized\_xf}_{ij} {xidf}_{j} ) \times wt\_cf$$

13. A method for retrieving contextual information by searching an ontology and one or more databases, as per claim 11, wherein said information retrieval statistic further comprises calculating a weight contributed by a particular category in said ontology by a occurrence of word i in a learning vector j, said weight given by:
wtᵢⱼ=(0.4+0.6×Normalized_{—}tf ᵢⱼxidfⱼ)×wt_{—}cf

14. A method for retrieving contextual information by searching an ontology and one or more databases, as per claim 11, wherein said weight further depends on a contribution frequency, said contribution frequency given by the number of annotations (that comprises said learning instance) in which said word i appears.

15. A method for retrieving contextual information by searching an ontology and one or more databases, as per claim 11, wherein said annotations are retrieved from any of the following sources: text documents, message boards, chat rooms, product descriptions, and multimedia documents comprising audio, video, images, and graphics in various formats.

16. A method for retrieving contextual information by searching an ontology and one or more databases, as per claim 11, wherein said annotations are viewable via any of the following devices: an interactive television, a computer, or a handheld device, connected to the Internet, a cable system, or a wireless network.

17. A method for retrieving contextual information by searching an ontology and one or more databases, as per claim 11, wherein said databases are located on a network.

18. A method for retrieving contextual information by searching an ontology and one or more databases, as per claim 17, wherein said network is any of the following: local area network (LAN), wide area network (WAN), wireless network, world wide web (WWW), or Internet.

19. A system for retrieving contextual information by searching for a selected multimedia representation, said system comprising:
a server, said server receiving requests for contextual information for a selected multimedia representation;
one or more databases associated with said server,
wherein said server retrieves both from its own ontology, said ontology having automatically mapped annotations, and from said one or more databases said requested contextual information, and renders said retrieved information as an integrated presentation comprising said multimedia and said retrieved contextual information.

20. A system for retrieving contextual information by searching for a selected multimedia representation, as per claim 19, wherein said information retrieval statistics includes calculating the following parameters:
$$1 ) {Normalized\_tf}_{ij} = 0.4 + 0.6 \times \frac{log ( {tf}_{ij} + 0.5 )}{log ( {max\_tf}_{j} + 1 )} \\ 2 ) {idf}_{i} = \frac{log ( \frac{N}{{df}_{i}} )}{log ( N )} \\ 3 ) wt\_cf = ( 0.5 + \frac{cf}{tc} ) ( 1.0 - \frac{0.5}{1 + 0.05 t {c}^{2}} )$$
wtᵢⱼ=(0.4+0.6×Normalized_{—}tf ᵢⱼxidfⱼ)×wt_{—}cf

21. A system for retrieving contextual information by searching for a selected multimedia representation, as per claim 19, wherein said information retrieval statistic further comprises calculating a weight contributed by a particular category in said ontology by a occurrence of word i in a learning vector j, said weight given by:
wtᵢⱼ=(0.4+0.6×Normalized_{—}tf ᵢⱼxidfⱼ)×wt_{—}cf

22. A system for retrieving contextual information by searching for a selected multimedia representation, as per claim 21, wherein said weight further depends on a contribution frequency, said contribution frequency given by the number of annotations (that comprises said learning instance) in which said word i appears.

23. A system for retrieving contextual information by searching for a selected multimedia representation, as per claim 19, wherein said contextual information are retrieved from any of the following sources: text documents, message boards, chat rooms, product descriptions, and multimedia documents comprising audio, video, images, and graphics in various formats.

24. A system for retrieving contextual information by searching for a selected multimedia representation, as per claim 19, wherein said contextual information is accessible via any of the following devices: an interactive television, a computer, or a handheld device, connected to the Internet, a cable system, or a wireless network.

25. A system for retrieving contextual information by searching for a selected multimedia representation, as per claim 19, wherein said databases are located on a network.

26. A system for retrieving contextual information by searching for a selected multimedia representation, as per claim 25, wherein said network is any of the following: local area network (LAN), wide area network (WAN), wireless network, world wide web (WWW), or Internet.

27. A method for automatically mapping annotations to ontologies, said method comprising the steps of:
extracting annotations from a multimedia document segment;
mapping said extracted multimedia document segment to an appropriate node in said ontology;
comparing to other related content mapped to said appropriate node, and
integrating said related content with said extracted multimedia document segment.

28. A method for automatically mapping annotations to ontologies, as per claim 27, wherein pre-certification of said related content is required before said integration step.

29. A method for automatically mapping annotations to ontologies, as per claim 27, wherein said step of integration is accomplished via dynamic content linking.

30. A method for automatically mapping annotations to ontologies, as per claim 27, wherein said annotations are retrieved from any of the following sources: text documents, message boards, chat rooms, product descriptions, and multimedia documents comprising audio, video, images, and graphics in various formats.

31. A method for automatically mapping annotations to ontologies, as per claim 27, wherein said annotations are accessible via any of the following devices: an interactive television, a computer, or a handheld device, connected to the Internet, a cable system, or a wireless network.

32. An article of manufacture comprising a computer usable medium having computer readable program code embodied therein which searches an ontology of mapped multimedia annotations for appropriate annotations for one more multimedia documents, said ontology comprising one or more nodes, said article comprising:
a. computer readable program code receiving a request for searching and extracting one or more annotations related to said multimedia documents from said ontology;
b. computer readable program code identifying nodes in said ontology that are relevant to said multimedia documents, said nodes further comprising fused learning instances formed by fusing annotations in each of said nodes, said identification based upon using special statistics including term frequency, inverse document frequency and contribution frequency;
c. computer readable program code extracting information from said identified relevant nodes, and
d. computer readable program code dynamically linking said extracted information with said multimedia documents.
